(19) United States
(12) Patent Application Publication
(10) Pub. No.: US 2023/0344284 A1
(43) Pub. Date: Oct. 26, 2023

(54) TERMINAL MODULE CAPABLE OF WIRELESS CHARGING AND METHOD OF WIRELESS CHARGING FOR TERMINAL

(71) Applicant: Dong In KIM, Seoul (KR)

(72) Inventor: Dong In KIM, Seoul (KR)

(21) Appl. No.: 18/041,377

(22) PCT Filed: Jun. 15, 2021
(86) PCT No.: PCT/KR2021/007504

§ 371 Date: Feb. 10, 2023

(30) Foreign Application Priority Data
Nov. 8, 2020 (KR) 10-2020-0100357

(51) Int. Cl. H02J 50/90; H02J 50/10; H02J 50/20

(52) U.S. Cl. CPC H02J 50/90; H02J 50/10; H02J 50/20

(57) ABSTRACT

The present invention relates to a terminal module capable of wireless charging capable of wireless charging of a magnetic induction method and an RF method but selectively determining a wireless charging method, and a method of wireless charging for a terminal. The terminal module capable of wireless charging includes: a first terminal including a first induction unit for performing electromagnetic induction, and a first transmission unit transmitting an RF signal; a second terminal including a second reaction unit responsive to the first induction unit of the first terminal, a second reception unit receiving the RF signal from the first transmission unit of the first terminal, and a second induction unit performing the electromagnetic induction; and a third terminal including a third reaction unit reacted by the first induction unit or the second induction unit, and a third reception unit receiving the RF signal transmitted from the first transmission unit.

### CROSS-REFERENCE TO RELATED APPLICATIONS

This application claims the priority of Korean Patent Application No. 10-2020-0100357 filed on Aug. 11, 2020, in the Korean Intellectual Property Office, the disclosure of which is incorporated herein by reference.

### BACKGROUND OF THE INVENTION

### Field of the Invention

The present invention relates to a terminal module capable of wireless charging and a method of wireless charging for a terminal, which are capable of wireless charging of a magnetic induction method and an RF method, but selectively determining a wireless charging method.

### Description of the Related Art

In general, wireless charging means charging without a wire between components of a power transmitting side and a power receiving side. Broadly, the wireless charging can be divided into a wireless charging method through an electromagnetic induction method and a wireless charging method through an RF method. In recent electronic products, especially in the case of mobile phones, wireless charging has been commercialized and widely used. Mainly, the wireless charging method of the above-described electromagnetic induction method has been adopted, and there are cases in which the technology of the RF method is applied.

Each wireless charging method, which has advantages and disadvantages such as portability and charging efficiency within a predetermined space, can respond to user convenience more if the user can selectively decide. Therefore, there has been a demand for a terminal capable of such wireless charging, but capable of selectively using a magnetic induction method or an RF method by a user.

### SUMMARY OF THE INVENTION

An exemplary embodiment of the present invention has been made in an effort to be wireless charging through magnetic induction and RF signal transmissions methods, and selectively apply a charging method.

Another exemplary embodiment of the present invention has been made in an effort to simultaneously perform the magnetic induction method and the RF signal transmission method at a power transmitting side.

The present invention relates to a terminal module capable of wireless charging capable of wireless charging of a magnetic induction method and an RF method but selectively determining a wireless charging method, and a method of wireless charging for a terminal. The terminal module capable of wireless charging includes: a first terminal including a first induction unit for performing electromagnetic induction, and a first transmission unit transmitting an RF signal; a second terminal including a second reaction unit responsive to the first induction unit of the first terminal, a second reception unit receiving the RF signal from the first transmission unit of the first terminal, and a second induction unit performing the electromagnetic induction; and a third terminal including a third reaction unit reacted by the first induction unit or the second induction unit, and a third reception unit receiving the RF signal transmitted from the first transmission unit.

In addition, the electromagnetic induction may be preferentially performed when the electromagnetic induction is performed between two terminals among the first terminal, the second terminal, and the third terminal and all transmission and reception conditions of the RF signal are satisfied.

Further, the electromagnetic induction is performed by a contact between two or more terminals among the first terminal, the second terminal, and the third terminal, and transmission and reception of the RF signal is possible in a contact or non-contact state within a predetermined radius range between two or more terminals among the first terminal, the second terminal, and the third terminal.

Further, the first terminal may include a first location correction unit which is a magnetic body, and at least one of the second terminal and the third terminal at least includes a second location correction unit which is the magnetic body at a location corresponding to the first location correction unit, and a contact by the first location correction unit and the second location correction unit may enable the first induction unit and the second reaction unit or the first induction unit and the third reaction unit to be disposed at locations corresponding to each other.

Further, the first terminal reacts the second reaction unit through the first induction unit, and simultaneously, is capable of transmitting the RF signal to the third transmission unit through the first transmission unit.

Provided is a method of wireless charging for a terminal in which a first terminal including a first induction unit performing electromagnetic induction and a first transmission unit transmitting an RF signal is provided, a second terminal including a second reaction unit reacted by the first induction unit and a second reception unit receiving the RF signal transmitted from the first transmission unit is wirelessly charged by the first induction unit or the first transmission unit, and power charged in the second terminal charges the third terminal by reacting a third reaction unit of a third terminal by the electromagnetic induction of a second induction unit included in the second terminal, and when a condition chargeable through a third reception unit included in the third terminal and the third reaction unit is satisfied, charging is performed through the third reaction unit.

In addition, when a condition for charging through a reaction of the third reaction unit by the first induction unit and a condition for charging through a reaction of the third reception unit by the first transmission unit are simultaneously satisfied, the charging may be achieved through the reaction of the third reaction unit by the first induction unit.

According to an exemplary embodiment of the present invention, a terminal module which is capable of wireless charging and a method of wireless charging for a terminal can be provided which are capable of wireless charging through magnetic induction and RF signal transmission methods, and selectively applying a charging method among them to maintain a charging state even in a situation in which a transmitting side and a receiving side of power are in contact with or are spaced apart from each other.

According to an exemplary embodiment of the present invention, a terminal module which is capable of wireless charging and a method of wireless charging for a terminal can be provided in which a transmitting component is separately provided so as to simultaneously perform the magnetic induction method and the RF signal transmission method at the transmitting side of the power.

### BRIEF DESCRIPTION OF THE DRAWINGS

FIG. 1 is a perspective view illustrating a terminal module according to an exemplary embodiment of the present invention.

FIG. 2 is a diagram illustrating a case where the terminal module is capable of performing wireless charging according to an exemplary embodiment of the present invention.

FIG. 3 is a function diagram illustrating a power transmission direction in all cases in which the terminal module performs wireless charging according to an exemplary embodiment of the present invention.

FIG. 4 is a diagram illustrating an exemplary embodiment of a terminal module which is capable of simultaneously wireless charging according to an exemplary embodiment of the present invention.

FIG. 5 is a diagram illustrating another exemplary embodiment of a terminal module which is capable of simultaneously wireless charging according to an exemplary embodiment of the present invention.

### DETAILED DESCRIPTION OF THE PREFERRED EMBODIMENT

Hereinafter, specific exemplary embodiments of the present invention will be described with reference to the accompanying drawings. However, this is just an example and the present invention is not limited thereto.

In describing the present invention, a detailed description of the known art related with the present invention will be omitted when it is judged that the detailed description may unnecessarily make the gist of the present invention unclear. In addition, terms to be described below as terms which are defined in consideration of functions in the present invention may vary depending on the intention of a user or an operator or usual practice. Accordingly, the terms need to be defined based on contents throughout this specification.

The technical idea of the present invention is determined by the claims, and the following embodiments are just one means for efficiently explaining the technical idea of the present invention to those skilled in the art to which the present invention belongs.

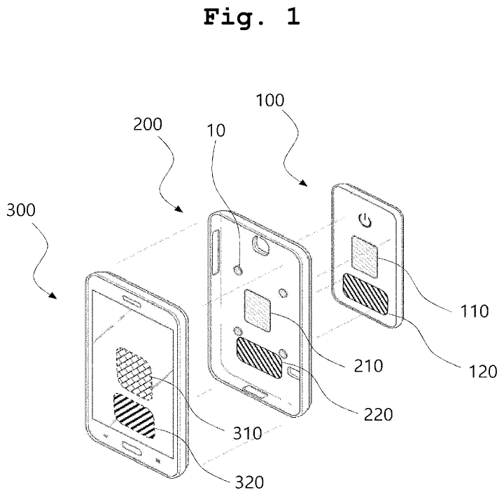

FIG. 1 is a perspective view illustrating a terminal module according to an exemplary embodiment of the present invention. The shapes of a first terminal 100, a second terminal 200, and a third terminal 300 illustrated in FIG. 1 are not limited to the illustrated example and can be changed, and shapes and layouts of a first transmission unit 120, a first induction unit 110, a second reception unit 220, a second reaction unit 211, a second induction unit 212, a third reception unit 320, a third reaction unit 310, and a location correction unit 10 are one example of a schematic view for assisting understanding of a description, and can be variously changed.

Referring to FIG. 1, the terminal module includes the first terminal 100, the second terminal 200, and the third terminal 300. Here, each terminal includes a component for performing wireless charging by magnetic induction and a component for performing wireless charging by transmitting and receiving RF signals. However, at the time of wireless charging, the terminal on the power receiving side may perform wireless charging through one of the component of performing wireless charging by magnetic induction and the component of wireless charging by transmitting and receiving the RF signals, and selectively determine the component by adjusting a charging condition.

For example, ⊚ which is to attempt charging through the magnetic induction wireless charging method may be achieved through a contact between the power transmitting side and the power receiving side. Here, the contact may not be a direct contact between the transmitting and receiving units, but may be a contact between terminals including the same. That is, the contact may be performed only when the terminals are located within a predetermined distance.

On the other hand, when charging is attempted by transmitting and receiving an RF signal, the charging may be achieved by satisfying a condition in which the power receiving side is located within a predetermined range from the power transmitting side. The predetermined range may be, for example, a radius of 10 m. Of course, the predetermined range is not limited to the radial distance and may vary depending on the effective transmission distance of RF signal transmission.

When the configuration of each terminal is described in detail, first, the first terminal 100 may be charged by external power. The charging may be selectively employed regardless of a wired or wireless charging method. That is, a component for power transmission may be selectively determined, and this is not a limitation.

However, the first terminal 100 includes the first induction unit 110 and the first transmission unit 120. Here, the first induction unit 110, which is a component provided on the power transmission side to perform wireless charging from the first terminal 100 in the magnetic induction method, may be operated when the power receiving side approaches the first induction unit 110 as long as a predetermined distance. In addition, the first transmission unit 120 is a component transmitting the RF signal from the first terminal 100, and the wireless charging may be achieved when a receiving component corresponding to the first transmission unit 120 receives the RF signal.

In addition, the wireless charging module includes the second terminal 200, and preferably, the second terminal 200 may be referred to as a case for protecting a general user device described as the third terminal 300. The second terminal 200 may be wirelessly charged by magnetic induction and the RF signal with the first terminal 100. The second terminal 200 includes a magnetic induction unit 210, and the magnetic induction unit 210 includes a second reaction unit 211 and a second induction unit 212 that reacts from the first induction unit 110 to generate power. Further, the magnetic induction unit 210 may include a second reception unit 220 receiving the RF signal from the first transmission unit 120.

The second induction unit 212 may enable the third terminal 300 to be charged through the magnetic induction method, and the third terminal 300 may include a third reaction unit 310 that reacts with the magnetic induction of the second induction unit 212. In addition, the third terminal 300 may include a third reception unit 320. The third reception unit 320 receives the RF signal transferred from the first transmission unit 120 of the first terminal 100 to allow the third terminal 3000 to be wirelessly charged.

Meanwhile, at least one of the first terminal 100, the second terminal 200, and the third terminal 300 may include the location correction unit 10. The location correction unit 10 is a component that maintains a contact state and assists in the correction of the contact location when the wireless charging is performed using the electromagnetic induction method, and located on the periphery of one of the first induction unit 110, the second reaction unit 211, the second induction unit 212, and the third reaction unit 310. For example, one or a plurality of location correction units may be provided on the same radial line centered on the first induction unit 110 and may be configured in a form to extend along the radius. In addition, the location correction unit 10 may be disposed on the terminal through a thin film or printed method. Furthermore, a magnetic material is separately provided in another terminal in contact with the terminal provided with the location correction unit 10, and the contact location between the terminals may be corrected at a location corresponding to the location correction unit 10. Through this, the wireless charging through the magnetic induction method may be performed more effectively.

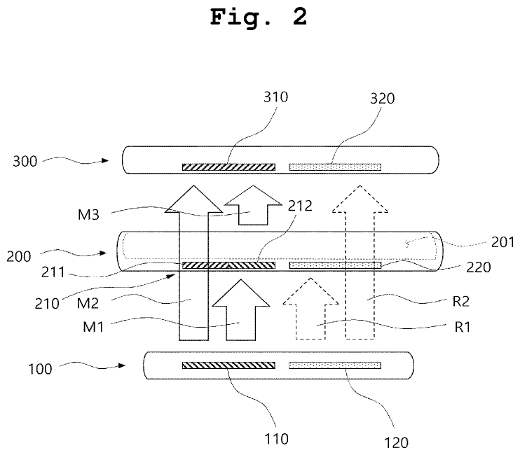

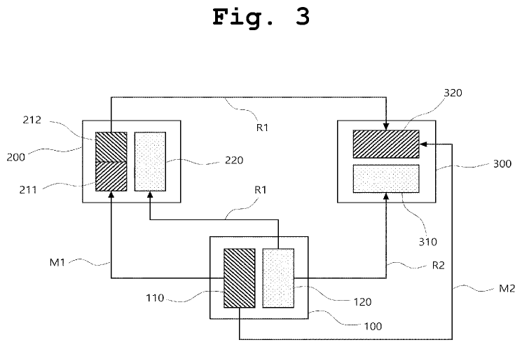

FIG. 2 is a diagram illustrating a case where the terminal module is capable of performing wireless charging form the side according to an exemplary embodiment of the present invention and FIG. 3 is a functional diagram thereof.

Referring to FIGS. 2 and 3, the first terminal 100 may transfer wireless charging signals in four cases. First, a 1-1^{st} induction signal M1 may be transferred. The 1-1^{st} induction signal M1 may be a signal transferred from the first terminal 100 to the second terminal 200, and specifically, may be a signal which the first induction unit 110 transfers to the second reaction unit 211. That is, the second reaction unit 211 reacts with the 1-1^{st} induction signal M1, so the second terminal 200 may be charged.

First, a 1-2^{nd} induction signal M2 may be transferred. The 1-2^{nd} induction signal M2 may become a signal transferred from the first terminal 100 to the second terminal 200. Specifically, the 1-2^{nd} induction signal M2 may a signal which the first induction unit 110 transfers to the third reaction unit 310, and the third terminal 300 may be charged through the signal.

The 1-1^{st} induction signal M1 and the 1-2^{nd} induction signal M2 may be signals transferred to cause the magnetic induction, and charging may be performed in the case of the contact between the terminals or in the case where the terminals are within a predetermined distance due to characteristics of the method. That is, in the case of the 1-1^{st} induction signal M1, the charging by the magnetic induction may be performed while the first terminal 100 and the second terminal 200 are in contact with each other, and in the case of the 1-2^{nd} induction signal M2, the charging by the magnetic induction may be performed while the first terminal 100 and the third terminal 300 are in contact with each other.

The predetermined distance may mean a separated distance, and for example, may become a distance separation of several mms between the terminals. Of course, as the separation distance decreases, it is advantageous in terms of charging efficiency, and for example, the second terminal 200 or the third terminal 300 may be seated on the first terminal 100.

Third, the first terminal 100 may transfer a 2-1^{st} RF signal. The 2-1^{st} RF signal which transfers the RF signal may cause charging at an RF signal receiving side even in a non-contact state. Here, the receiving side may be the second reception unit 220, and even in the case where the second terminal 200 is separated from the first terminal 100, the second reception unit 220 of the second terminal 200 receives the 2-1^{st} RF signal to perform the wireless charging. Of course, the 2-1^{st} RF signal is enabled to be received within a predetermined distance, and for example, the predetermined distance may be a radius of 10 m.

Fourth, the first terminal 100 may transfer a 2-2^{nd} RF signal. The 2-2^{nd} RF signal which transfers the RF signal may be transferred from the first transmission unit 120 to the third reception unit 320. When the third reception unit 320 receives the 2-2^{nd} RF signal, the third terminal 300 may be wirelessly charged. Of course, the 2-2^{nd} RF signal is also enabled to be received within a predetermined distance, and for example, the predetermined distance may be the radius of 10 m.

However, with respect to the 2-1^{st} RF signal and the 2-2^{nd} RF signal, as a signal transfer distance increases, the radius may further increase, and as a result, a valid charging range may increase.

Meanwhile, there is a 2-2^{nd} induction signal transferred from the second terminal 200. The 2-2^{nd} induction signal may be transferred from the second induction unit 212 of the second terminal 200 to the third reaction unit 310 of the third terminal 300. The 2-2^{nd} induction signal is a signal which enables charging to be achieved through the reaction for the magnetic induction, and the 2-2^{nd} induction signal is transferred, and therefore, it is advantageous that the second terminal 200 and the third terminal 300 are in a contact state in order for the third reaction unit 310 to react. For example, the second terminal 200 is a cellular phone case, and the third terminal 300 becomes a cellular phone, and as a result, the third terminal 300 is coupled to the second terminal 200, and the second terminal 200 and the third terminal 300 may maintain the contact state.

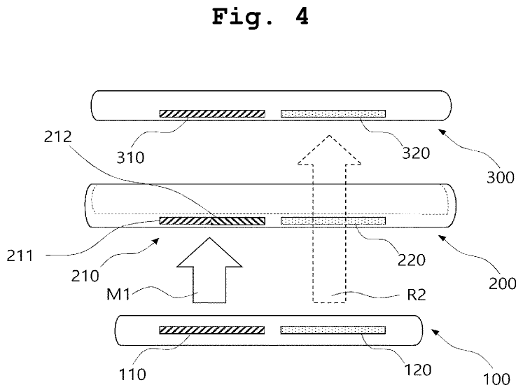

FIG. 4 is a diagram illustrating an exemplary embodiment in which wireless charging is simultaneously enabled by the first terminal 100 according to an exemplary embodiment of the present invention.

Referring to FIG. 4, the wireless charging may be achieved simultaneously. This does not means that the terminal at the receiving side is simultaneously charged through two means of the magnetic induction method and the RF method, but means that a plurality of receiving-side components are wirelessly charged by one transmitting-side component. For example, the second terminal 200 and the third terminal 300 may be simultaneously charged from the first terminal 100.

Specifically, when the 1-1^{st} induction signal M1 is transferred from the first induction unit 110 of the first terminal 100 to the second reaction unit 211 of the second terminal 200, the second terminal may be charged. For example, when the second terminal 200 is seated on the first terminal 100 and disposed in the contact state, the second terminal 200 may be wirelessly charged. Simultaneously, when the 1-2^{nd} RF signal R2 is transferred from the first transmission unit 120 of the first terminal 100 to the third reception unit 320 of the third terminal 300 in the non-contact state, the third terminal 300 may be charged.

In this case, according to whether the signal transferred from the first transmission unit 120 is transferred to the second reception unit 220 or the third reception unit 320, the signal may be referred to as the 1-1^{st} RF signal R1 or the 1-2^{nd} RF signal R2, and in the case where the second terminal 200 and the third terminal 300 are located within a range in which the RF signal is transferable from the first terminal 100, the third terminal 300 may preferentially receive the RF signal. That is, a priority in which the RF-method wirelessly charging is performed is given to the third terminal 300.

Further, the wireless charging may be selectively performed based on the receiving-side terminal. Here, the selective performing means that the charging may be performed by adopting one charging method of the magnetic induction method or RF method charging method, and is possible by satisfying a charging condition corresponding to each method. Further, in a state in which all charging requirements of respective charging methods are satisfied, the magnetic induction method wireless charging method may be preferentially performed.

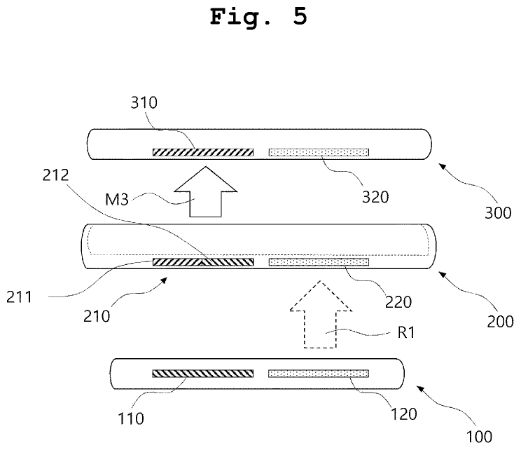

FIG. 5 is a diagram illustrating another exemplary embodiment in which wireless charging is simultaneously enabled by the first terminal 100 according to an exemplary embodiment of the present invention.

Referring to FIG. 5, as another example of simultaneous charging, as described above, in a state in which both charging conditions required by two charging methods are satisfied, the magnetic induction method wireless charging may be preferentially performed. In this example, in a state in which the third terminal 300 contacts the second terminal 200 and the third reaction unit 310 reacts by the second induction unit 212 and the third terminal 300 is charged, the third terminal 300 does not receive the RF signal transferred by the first terminal 100. Therefore, the RF signal transferred from the first transmission unit 120 may not become the 1-2^{nd} RF signal R2, but the 1-1^{st} RF signal R1. That is, the RF signal is not transferred from the first transmission unit 120 to the third reception unit 320, and may be transferred to the second reception unit 220. Through this, simultaneous charging in which the third terminal 300 and the second terminal 200 are simultaneously charged may be achieved.

Although representative embodiments of the present invention have been described in detail hereinabove, it will be appreciated by those skilled that various modifications of the exemplary embodiment of the present invention can be made in the art within a limit without departing from the scope of the present invention. Therefore, the scope of the present invention should not be limited to the exemplary embodiments and should be defined by the appended claims and equivalents to the appended claims.

1. A terminal module which is capable of wireless charging, comprising:
a first terminal including a first induction unit performing electromagnetic induction and a first transmission unit transmitting an RF signal; and
a third terminal including a third reaction unit reacted by the first induction unit and a third reception unit receiving the RF signal transmitted from the first transmission unit,
wherein the first terminal includes a first location correction unit which is a magnetic body, and the third terminal at least includes a second location correction unit which is the magnetic body at a location corresponding to the first location correction unit, and
a contact by the first location correction unit and the second location correction unit enables the first induction unit and the third reaction unit to be disposed at locations corresponding to each other.

2. The terminal module of claim 1, wherein the electromagnetic induction is preferentially performed when the electromagnetic induction is performed between the first terminal and the third terminal and all transmission and reception conditions of the RF signal are satisfied.

3. The terminal module of claim 2, wherein the electromagnetic induction is performed by a contact between the first terminal and the third terminal, and transmission and reception of the RF signal is possible in a contact or non-contact state within a predetermined radius range between the first terminal and the third terminal.

4.-6. (canceled)

7. The method of claim 1, wherein when a condition for charging through a reaction of the third reaction unit by the first induction unit and a condition for charging through a reaction of the third reception unit by the first transmission unit are simultaneously satisfied, the charging is achieved through the reaction of the third reaction unit by the first induction unit.
